(19) United States
(12) Patent Application Publication
(10) Pub. No.: US 2017/0208242 A1
(43) Pub. Date: Jul. 20, 2017

(54) INFORMATION PROCESSING APPARATUS, INFORMATION PROCESSING METHOD, AND COMPUTER-READABLE NON-TRANSITORY RECORDING MEDIUM

(71) Applicant: CANON KABUSHIKI KAISHA, Tokyo (JP)

(72) Inventor: Yuichi TSUNEMATSU, Kawasaki-shi (JP)

(21) Appl. No.: 15/409,968

(22) Filed: Jan. 19, 2017

(30) Foreign Application Priority Data
Jan. 20, 2016 (JP) 2016-009138

(51) Int. Cl. H04N 5/232; H04N 5/77; H04N 7/18

(52) U.S. Cl. CPC H04N 5/23216; H04N 7/181; H04N 5/23293; H04N 5/77

(57) ABSTRACT

An information obtaining unit obtains setting information indicating a setting of image analysis processing performed on image data recorded in a recording unit which records the image data captured in an image capturing unit. A decision unit decides, in accordance with the setting information, a value of a parameter for the image data to be recorded by the recording unit, which influences a data amount of the image data, or a range of the value of the parameter.

### BACKGROUND OF THE INVENTION

### Field of the Invention

The present invention relates to an information processing apparatus, an information processing method, and a computer-readable non-transitory recording medium and, more particularly, to a technique of making an image data long-term recording setting in a monitoring camera system.

### Description of the Related Art

The number of monitoring cameras used in one facility or system tends to increase, and a monitoring camera system is increasing in scale year by year. When establishing the system, the number of cameras, a network band, the connectable count, a video recording time, the quality of a recorded image, and the like are screened out from system requirements, and the system is designed to satisfy them, thereby procuring materials. A system setting is static and is decided in accordance with an operation status under the heaviest load.

In order to record a camera image of a longer time with a limited system resource, the image is recorded after being thinned-out and resized. For example, a frame rate for real time monitoring is set to 10 fps, and images for the last week are recorded at a frame rate of 2 to 3 fps. Further, a frame rate for recording over the long term of several weeks to several months or more is set to 0.2 to 1 fps so as to reduce a data size gradually. This makes it possible to prolong the longest recording period of the camera image, and to keep the latest video highly likely to be utilized with high image quality at a high frame rate. Video Management Software (VMS) used to form a monitoring system generally has a long-term recording function of such image data.

In order to implement more efficient recording, Japanese Patent Laid-Open No. 2005-151546 describes a technique of dividing image data into layers in accordance with the importance of a video and event information from an external sensor for recording, and deleting the data from the lower layer. Further, Japanese Patent Laid-Open No. 2007-36615 describes a technique of preferentially bringing the frame rate of each of a camera designated by a user, a camera which detects an abnormality, and an adjacent camera thereof to a target rate while suppressing the total video recording frame rate of an entire monitoring camera system to a predetermined rate or lower.

As the monitoring camera system increases in scale, various settings in the video management software become complicated. Especially in image analysis, the settings need to be changed minutely in accordance with the importance of a camera or a system load. Under present circumstances, an experienced person makes, based on his/her own experience, recording settings (selection of a recording destination disk, the operation timing of thinning/resizing of an image, and the like) and image analysis settings (the type of image analysis, an operation timing, and the like). Meanwhile, an image with a high resolution and a high frame rate needs to be used to perform image analysis accurately. In an environment in which tens/hundreds of cameras are connected, however, it is very difficult to make image analysis settings without a contradiction with long-term recording settings. Even though the person intends to make the setting properly, sufficient accuracy may not be obtained in image analysis or only an image that does not satisfy prerequisites needed for image analysis may remain at the start of image processing. It is very important to be able to easily make the image analysis settings and the long-term recording settings without any contradiction.

The present invention has been made in consideration of the above problems and provides a technique capable of setting image analysis and image recording appropriately.

### SUMMARY OF THE INVENTION

In order to provide a technique capable of setting image analysis and image recording appropriately, for example, the present invention has the following configuration. That is, an information processing apparatus which comprises: an information obtaining unit configured to obtain setting information indicating a setting of image analysis processing performed on image data recorded in a recording unit configured to record the image data captured by an image capturing unit; and a decision unit configured to decide, in accordance with the setting information, one of a value of a parameter for the image data to be recorded in the recording unit, which influences a data amount of the image data, and a range of the value of the parameter.

Further features of the present invention will become apparent from the following description of exemplary embodiments (with reference to the attached drawings).

### BRIEF DESCRIPTION OF THE DRAWINGS

FIG. 1 is a view showing a network connection configuration representing the operating environment of a monitoring system;

FIG. 2 is a block diagram showing the arrangement of the monitoring system;

FIG. 3 is a block diagram showing an example of the hardware arrangement of a management apparatus;

FIG. 4 is a view showing an example of installation of monitoring cameras;

FIG. 5 is a flowchart showing a processing procedure by the operation of an imaging system;

FIG. 6 is a table showing examples of the type of image analysis and the prerequisites of each analysis operation;

FIG. 7 is a table showing examples of image analysis settings;

FIGS. 8A to 8C are tables each showing an example of calculating lower limit values of image recording settings;

FIG. 9 is a table showing lower limit values of the image recording setting when setting the same recording condition among certain cameras:

FIG. 10 shows views each showing a state in which the frames of an image are thinned-out;

FIG. 11 is a table showing examples of disk operation statuses in a recording apparatus;

FIG. 12 is a table showing examples of the allocation of recording destinations in consideration of the disk operation statuses; and

FIG. 13 is a table showing an example of calculation of a data size recorded in each disk.

### DESCRIPTION OF THE EMBODIMENTS

The present invention will be described in detail below based on embodiments of the present invention with reference to the accompanying drawings. Note that arrangements shown in the following embodiments are merely examples, and the present invention is not limited to the illustrated arrangements.

### First Embodiment

(Monitoring System)

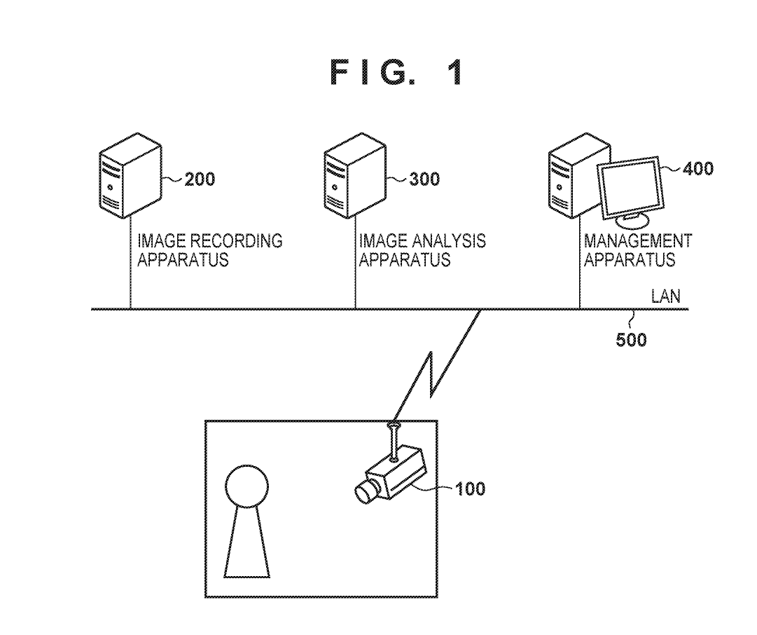

FIG. 1 is a view showing a network connection configuration representing the operating environment of a monitoring camera system (monitoring system apparatus) serving as an imaging system according to the first embodiment of the present invention. In the monitoring camera system, a monitoring camera 100, an image recording apparatus 200, an image analysis apparatus 300, and a management apparatus (image display apparatus) 400 are connected by a LAN 500 serving as a network line.

The monitoring camera 100 is an image capturing apparatus, and has a function of capturing an imaging target, encoding image data, and distributing it via a network. As will be described later, the imaging system includes the plurality of monitoring cameras 100. The image recording apparatus 200 is an apparatus (storage device) which has a network storage function and records an image, and records (stores), via the LAN 500, a plurality of image data captured by the plurality of monitoring cameras 100. The image analysis apparatus 300 performs image analysis processing on the image data recorded in the image recording apparatus 200. The management apparatus 400 is an information processing apparatus which manages the monitoring camera 100, the image recording apparatus 200, and the image analysis apparatus 300. More specifically, the management apparatus 400 displays the image data recorded in the image recording apparatus 200 and an image analysis result in the image analysis apparatus 300. Further, the management apparatus 400 also has a function of providing an instruction input device (a keyboard, a pointing device, or the like) to be used by a user to perform various operations such as the setting of image recording/image analysis.

Each of the image recording apparatus 200, the image analysis apparatus 300, and the management apparatus 400 is implemented by a general-purpose information processing apparatus such as a PC (personal computer) or a tablet terminal, but may be configured as a dedicated apparatus such as an embedded apparatus. In this embodiment, an example will be described in which the network line serving as a communication path among the apparatuses is formed by the LAN (Local Area Network). However, the network line may be any medium capable of performing communication via that line regardless of whether the line is wired or wireless. Further, in this embodiment, an example will be described for descriptive convenience in which the monitoring camera 100, the image recording apparatus 200, the image analysis apparatus 300, and the management apparatus 400, respectively, are formed by different apparatuses. However, all or some of these apparatuses may be implemented by one apparatus.

Monitoring Camera

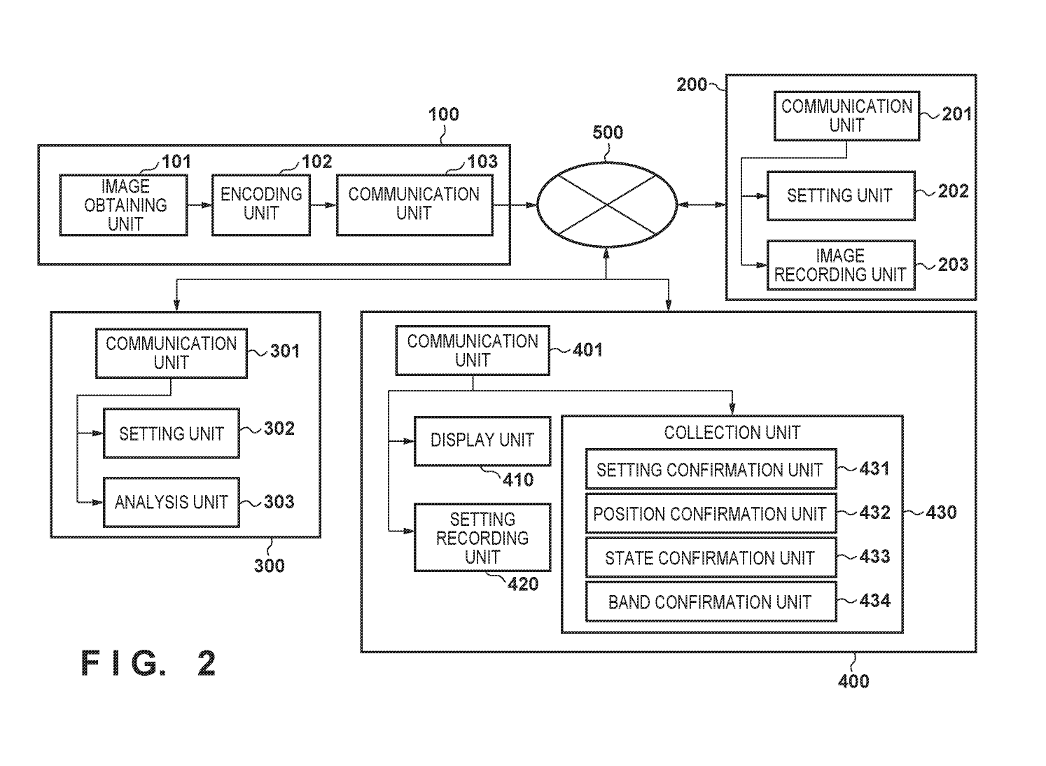

FIG. 2 is a block diagram showing the arrangement of the monitoring camera system according to this embodiment. The monitoring camera 100 performs predetermined pixel interpolation or color conversion processing on a digital electrical signal obtained by an image obtaining unit 101 from an image sensor such as a CMOS and develops/generates a digital image represented by an image space such as RGB or YUV. Image correction processing such as white balance, sharpness, contrast, color conversion, or the like is performed on the digital image that has been developed. An encoding unit 102 performs data encoding, in a compression format such as JPEG, Motion JPEG, or H.264 on the image data obtained by the image obtaining unit 101 for distributing an image via a network. Then, the encoded data is sent to the LAN 500 via a communication unit (image capturing apparatus communication unit) 103, and transferred to the image recording apparatus 200, the image analysis apparatus 300, and the management apparatus 400. In this embodiment, an example will be described in which moving image data (video) having a predetermined number or more of frames per unit time is captured. However, a still image may be captured.

Image Recording Apparatus

The image recording apparatus 200 receives, from the LAN 500, the recording setting of a distribution image and the distribution image via a communication unit (image recording apparatus communication unit) 201. When an image recording setting is received, a setting unit (image recording setting unit) 202 sets image recording. When an image is received, an image recording unit 203 records the image based on the setting made by the setting unit 202.

Image Analysis Apparatus

The image analysis apparatus 300 receives, via a communication unit (image analysis apparatus communication unit) 301, from the LAN 500, an image analysis setting and image data to undergo image analysis. When the image analysis setting is received, a setting unit (image analysis setting unit) 302 sets image analysis. Analysis target images are loaded from the monitoring camera 100 and the image recording apparatus 200, and analyzed by an analysis unit (image analysis unit) 303 based on the setting made by the setting unit 302.

Management Apparatus

The management apparatus 400 includes a communication unit (management apparatus communication unit) 401, a display unit 410, a setting recording unit (system setting recording unit) 420, and a collection unit (system status collection unit) 430. The communication unit 401 is a functional element which communicates with the monitoring camera 100, the image recording apparatus 200, and the image analysis apparatus 300 via the LAN 500. The display unit 410 displays an image, an image analysis result, and a user operation screen. The user inputs a setting concerning image recording or image analysis via the display unit 410.

In response to loading of a user instruction via the display unit 410, the image recording setting and the image analysis setting (setting information) are transmitted from the communication unit 401 to the image recording apparatus 200 and the image analysis apparatus 300. The setting recording unit 420 also holds the same contents. Besides the image recording setting and the image analysis setting, the setting recording unit 420 also holds information needed to manage the entire monitoring camera system, such as the installation position of the monitoring camera, the disk status of the image recording apparatus, and the congestion status of a network band.

The collection unit 430 collects the operation status of the monitoring camera system. The collection unit 430 includes a setting confirmation unit (image analysis setting confirmation unit) 431, a position confirmation unit (image capturing apparatus installation position confirmation unit) 432, a state confirmation unit (recording operation state confirmation unit) 433, and a band confirmation unit (network band confirmation unit) 434. The setting confirmation unit 431 is a functional element which confirms the image analysis setting set in the setting unit 302 of the image analysis apparatus 300. The position confirmation unit 432 is a functional element which confirms the installation position of the monitoring camera 100 serving as the image capturing apparatus. The state confirmation unit 433 is a functional element which confirms a recording operation state in the image recording unit 203 of the image recording apparatus 200. The band confirmation unit 434 is a functional element which confirms the communication band of communication in the LAN 500 serving as a network. As will be described later, for each of the plurality of image data of the plurality of monitoring cameras 100, the management apparatus 400 decides the format of the image data in the image recording apparatus 200 in accordance with the contents of analysis performed on the image data by the image analysis apparatus 300. This makes it possible to set, for each image, the recording setting according to the analysis contents without the user manually inputting the recording setting for each image. In this embodiment, an example in which the resolution (image size) or the frame rate of an image is set according to a recording time will be described as an example of an image format. However, the present invention is not limited to this. For example, the encoding method or the bit rate of the image, the ratio of an I frame, or the like may be set. These are examples of parameters which influence the data amount of the image data. These are also parameters which influence analysis precision in the image analysis processing.

In this embodiment, the respective functional elements described above are implemented by software based on a computer program in the general-purpose information processing apparatus such as the PC. However, all or some of the functional elements may be formed by dedicated hardware.

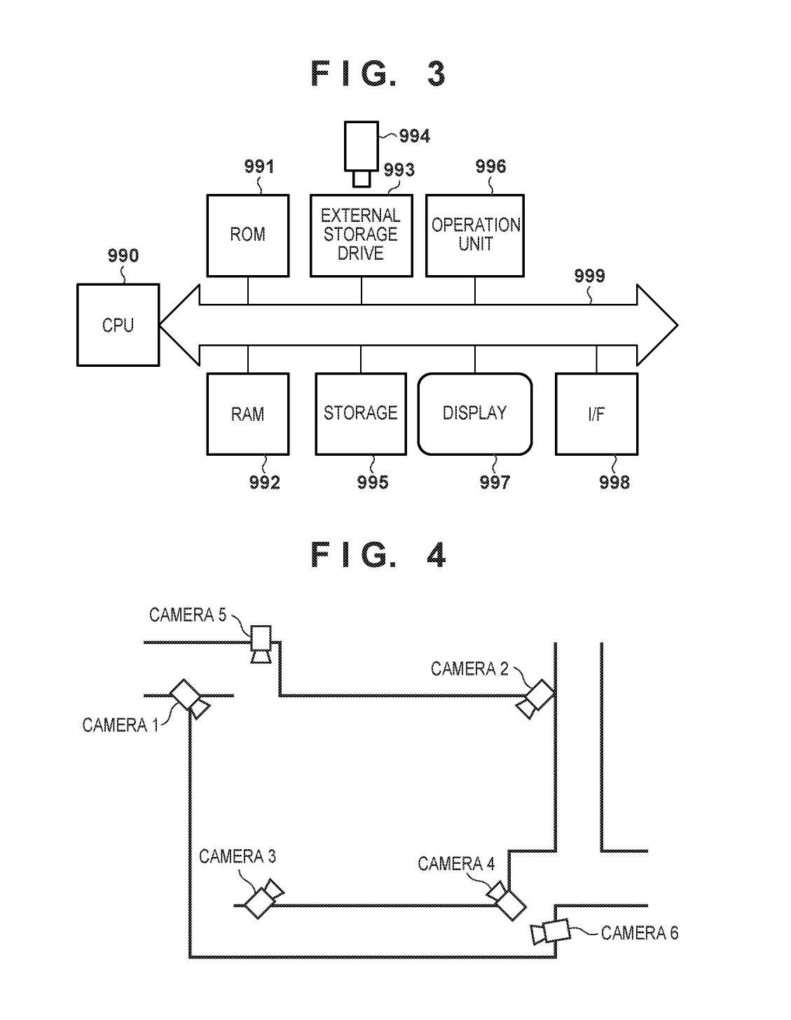

FIG. 3 is a block diagram showing an example of the hardware arrangement of the management apparatus 400. The same also applies to the hardware arrangements of the image recording apparatus 200 and the image analysis apparatus 300, and thus the management apparatus 400 will be described.

In FIG. 3, a CPU 990 is a central processing unit, and cooperates with other constituent elements based on the computer program to control the entire operation of the management apparatus 400. A ROM 991 is a read only memory, and stores a basic program, data used for basic processing, and the like. A RAM 992 is a writable memory and functions as the work area of the CPU 990 or the like. The CPU 990 controls the other constituent elements based on the computer program, making it possible to implement the collection unit 430.

An external storage drive 993 can implement access to a recording medium and can load, to this system, a computer program and data stored in a medium (recording medium) 994 such as a USB memory. A storage 995 is an apparatus which functions as a mass memory such as an SSD (solid state drive). The storage 995 stores various computer programs, and data such as the image recording setting and the image analysis setting.

An operation unit 996 is an apparatus which accepts the input of an instruction or a command from the user. The keyboard, the pointing device, a touch panel, or the like corresponds to this. A display 997 is a display device which displays the command input from the operation unit 996, a response output to the command from the management apparatus 400, and the like. The display unit 410 is implemented by the operation unit 996 and the display 997. An interface (I/F) 998 is an apparatus which relays a data exchange with an external apparatus. The communication unit 401 is implemented by the interface 998. A system bus 999 is a data bus which controls a data flow in the management apparatus 400.

(Processing Procedure)

With the above-described arrangement, the monitoring camera system (monitoring apparatus) according to this embodiment will be described in detail. FIG. 4 is a view showing an example of the arrangement of monitoring cameras to be used in the following description. Six cameras 1 to 6 are installed indoors, and monitor a room and a passage. FIG. 4 shows a situation in which cameras 1 to 5 capture the interior of the same room, and only camera 6 captures the passage.

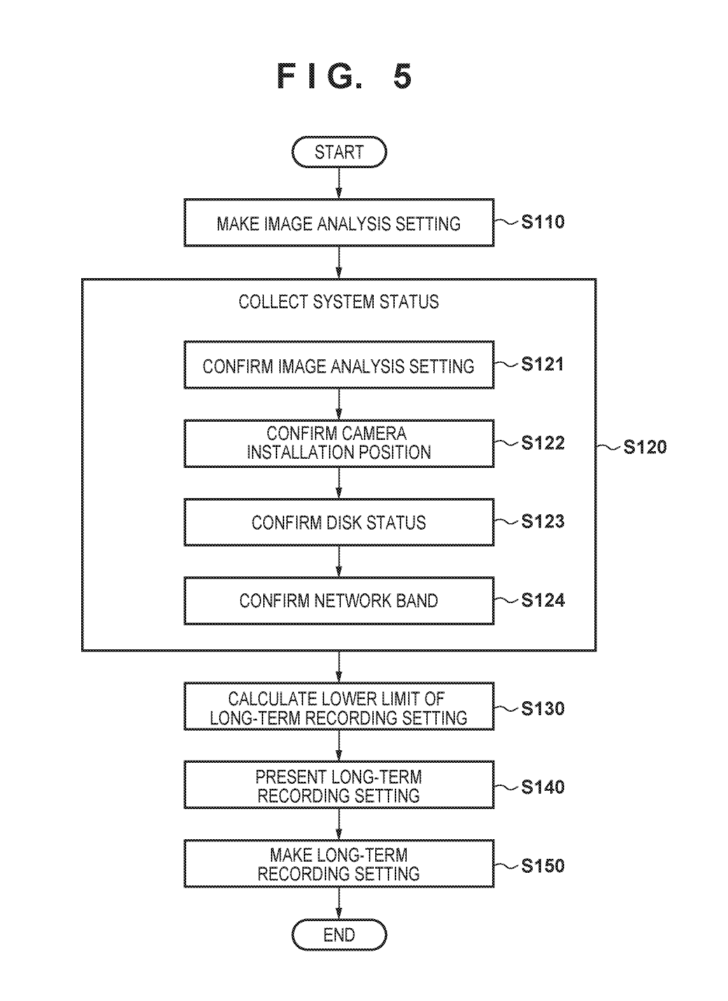

FIG. 5 shows a sequence operated by the user until a long-term image recording setting is made. FIG. 5 is a flowchart showing a processing procedure by the operation of the imaging system according to this embodiment. Each step of FIG. 5 is performed under the control of the CPU 990 of the management apparatus 400. Note that a case will be described in which real-time monitoring in the monitor requires an image resolution of 960×540 pixels and a lowest frame rate of 5 fps as predetermined values on the system side. In addition, one month is set as a lower limit for long-term recording, and a saved image has a minimum resolution of 480×270 and a minimum frame rate of 1 fps.

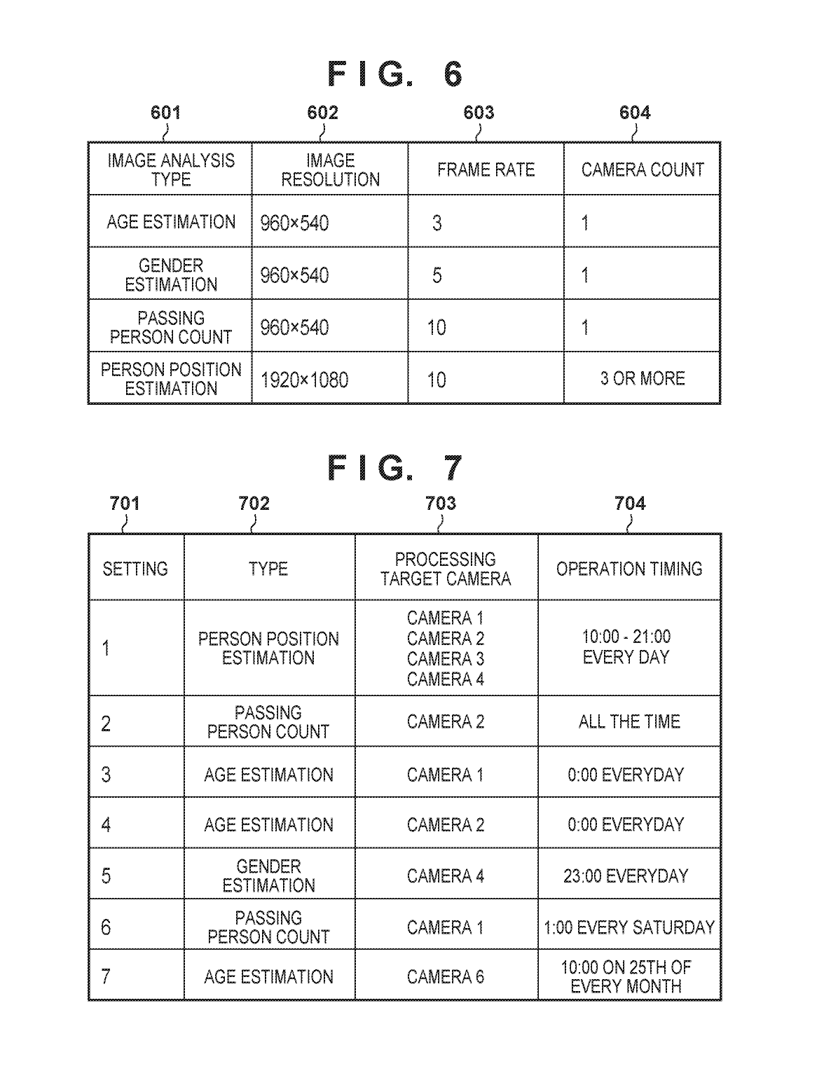

First, in step S110, an image analysis setting screen is displayed on the display unit 410 of the management apparatus 400 to cause the user to input the analysis setting. FIG. 6 is a table showing an example of image analysis that can be set by the user.

Prerequisites needed for an operation, such as an image resolution 602, a frame rate 603, and a camera count 604 are set for each image analysis operation in accordance with its type. An image analysis type 601 indicates the type of image analysis. As the image analysis type 601, FIG. 6 shows age estimation, gender estimation, a passing person count, and person position estimation. Age estimation is the type of image analysis in which the age of an object included in a captured image is estimated from the face image of the object. Gender estimation is the type of image analysis in which a gender is estimated from the face image of the object. The passing person count is the type of image analysis in which a person is identified between image frames, and the number of times that person crosses a virtual passage line during a predetermined imaging period is counted. Person position estimation is the type of image analysis in which the three-dimensional position of the object is estimated by the triangulation principle using three or more cameras calibrated in advance.

In addition, there is an image quality setting as a parameter which influences the precision of image analysis. Generally, image quality can be selected from low image quality (small data size) to high image quality (large data size) in five levels, though specifications are different depending on the monitoring cameras or video recording software. An example will be described here in which the image quality setting is set to 3 uniformly for simplicity. However, the image quality setting can also be treated as the prerequisite of the image analysis setting, similarly to the image resolution and the frame rate.

FIG. 7 is a table showing an example of image analysis actually set by an operator. A setting 701 as the consecutive number of image analysis, a type 702 of image analysis, a processing target camera 703, and a timing (operation timing 704) at which image analysis is performed are recorded in association with each other. Examples of the operation timing are “all the time”, “within a predetermined time”, and “a predetermined date and time”. For example, setting 1 indicates that image analysis of person position estimation is performed based on images captured by cameras 1 to 4 during a time from 10:00 to 21:00 every day. In this embodiment, person position estimation is performed at an image resolution of 1,920×1,080 and a frame rate of 10 fps (see FIG. 6), and thus each of cameras 1 to 4 captures an image under an imaging condition capable of such analysis. The thus set image analysis setting is recorded in the setting recording unit 420.

Then, in step S120, the collection unit 430 collects the system status. System status collection is divided into two processes inside. First, in step S121, the setting confirmation unit 431 confirms an image analysis setting designated by the user. More specifically, for example, contents shown in FIG. 7 are obtained as the image analysis setting. Next, in step S122, the position confirmation unit 432 obtains a region in which each camera is installed. This is obtained from the setting recording unit 420. In the installation status of FIG. 4, information that cameras 1 to 5 capture the same region is obtained. Note that in this embodiment, processes in steps S123 and S124 of FIG. 5 are not performed. An arrangement in which these processes are performed will be described in the second embodiment.

In step S130, the setting recording unit 420 calculates a lower limit in long-term recording setting. Here, the reduction timings of data are set for real-time monitoring, recording for the latest day, recording for the last week, and recording for the last month. Here, as an example, predetermined values of the system are as follows.

real-time monitoring: the image resolution is 960×540 pixels, and the frame rate is 5 fps

image to be saved: the image resolution is 480×270 pixels, and the frame rate is 1 fps.

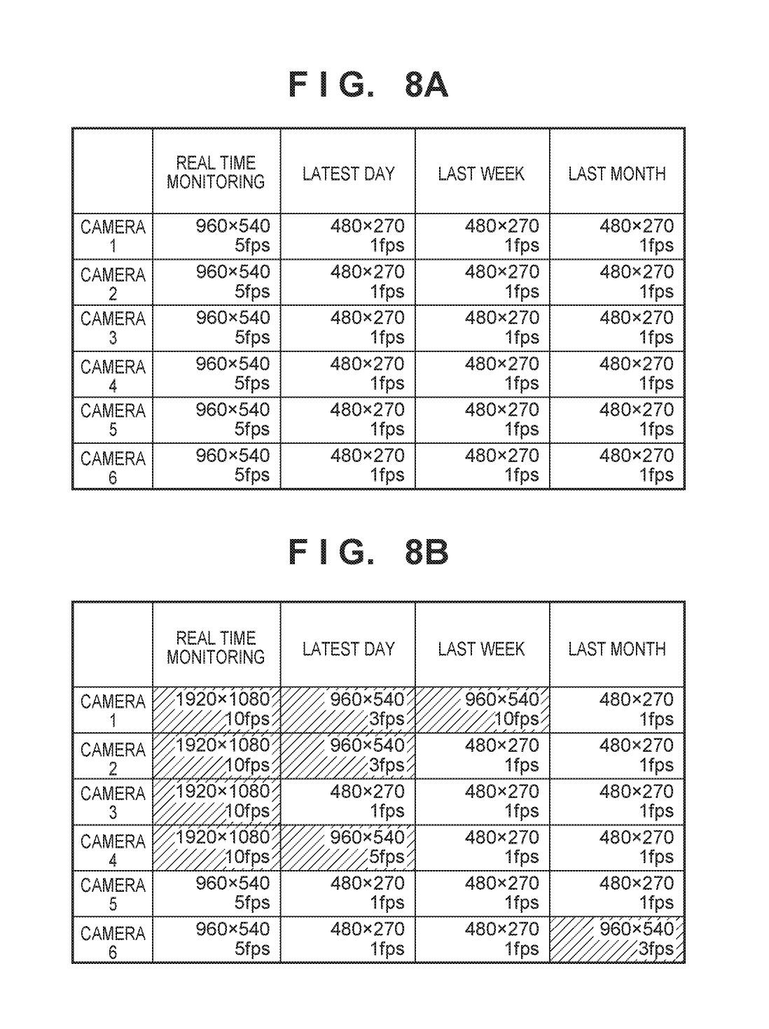

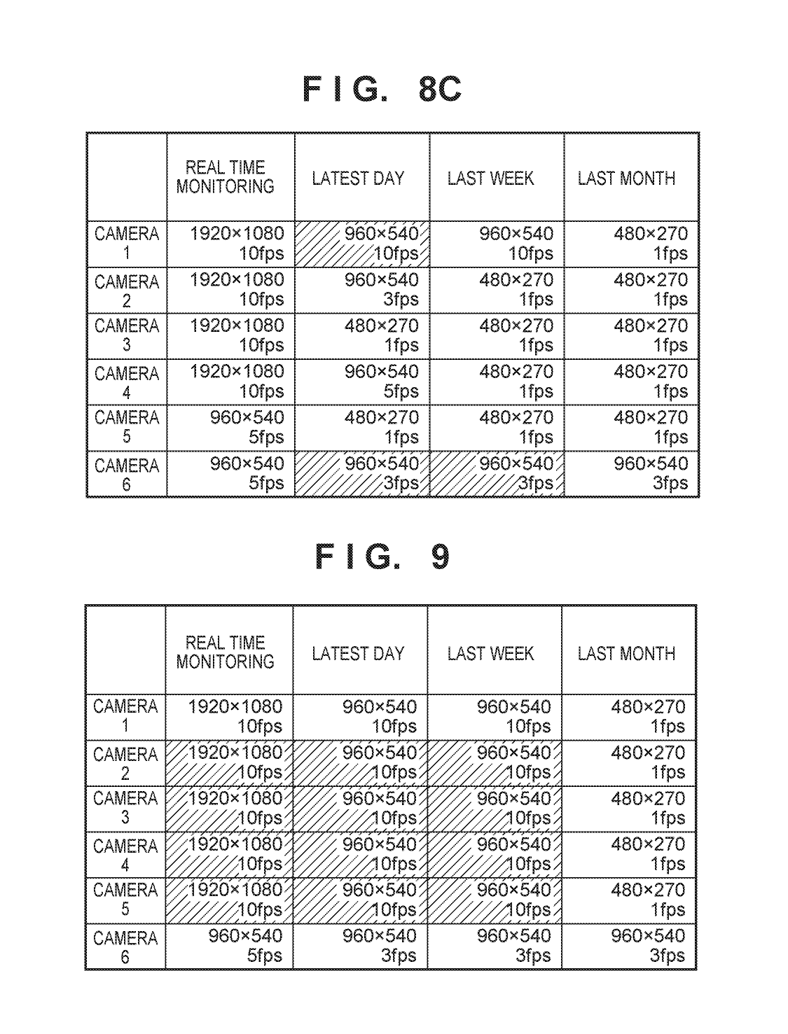

A lower limit in the long-term recording setting shown in FIG. 8C is obtained by combining the image analysis prerequisites of FIG. 6 and the information of the operation timings of image analysis set in FIG. 7.

This can be obtained by the following procedure. First, the predetermined values of the system described above are set in respective fields of an empty table. In the above-described example, 960×540 pixels and 5 fps are set in a column “real-time monitoring”, and 480×270 pixels and 1 fps are set in each of columns “the latest day”, “the last week”, and “the last month”. FIG. 8A shows an example of a table in which the predetermined values of the system are set.

Then, in accordance with the timings shown in 704 of FIG. 7 at which image analysis is operated, the image analysis prerequisites of FIG. 6 are set in the fields of the associated camera. If there exist a plurality of corresponding image analysis prerequisites, larger values of the image resolution and frame rate are set. In the example of FIG. 7, “person position estimation” of setting 1 and “passing person count” of setting 2 are performed in real time. Therefore, the image resolution and the frame rate shown in FIG. 6 are set in the “real-time monitoring” fields of cameras 1 to 4 to which setting 1 in FIG. 7 is applied and camera 2 to which setting 2 in FIG. 7 is applied. Although both “person position estimation” and “passing person count” are performed on the image captured by camera 2, the lower limit (1,920×1,080 pixels) of the image resolution for “person position estimation” that requires an image of a higher resolution is set. Similarly, image analysis operations of settings 3 to 5 are performed every day in the example of FIG. 7, and thus the values for “the latest day” of the respective cameras to which settings 3 to 5 are applied are set, based on the types of image analysis, to the values shown in FIG. 6. Image analysis (passing person count) of setting 6 is performed every week, and thus the value for “the last week” of the camera (camera 1) to which setting 6 is applied is set as the value of “passing person count” shown in FIG. 6. Image analysis (age estimation) of setting 7 is performed every month, and thus the value for “the last month” of the camera (camera 6) to which setting 7 is applied is set as the value of “age estimation” shown in FIG. 6. FIG. 8B shows an example of a table in which the image analysis prerequisites are set in accordance with the operation timings of the image analysis operations. In FIG. 8B, each hatched portion indicates a cell including a value modified from that in the table of FIG. 8A.

Finally, if a numeric value on the left is smaller than that on the right in each field, the value on the left is overwritten with the value on the right. Consequently, a lower limit value in a long-term saving setting that must be satisfied at minimum by the system is obtained. Lower limit values shown in FIG. 8C are obtained as a result of the computation described above. In FIG. 8C, each hatched portion indicates a cell including a value modified from that in the table of FIG. 8B. As described above, the management apparatus 400 decides, for each of the plurality of image data, a format having an information amount needed for analysis performed on the image data, making it possible to perform desired analysis.

As an application of an image capturing apparatus installation position, it is considered to set equal lowest resolutions and frame rates of images to be recorded in cameras capturing the same region. Depending on image processing, it is assumed that images are input from a plurality of cameras at the same time. This applies to person position estimation. When such image analysis is performed, the frame times of images to be left after thinning-out need to be made to match in the plurality of cameras capturing the same region.

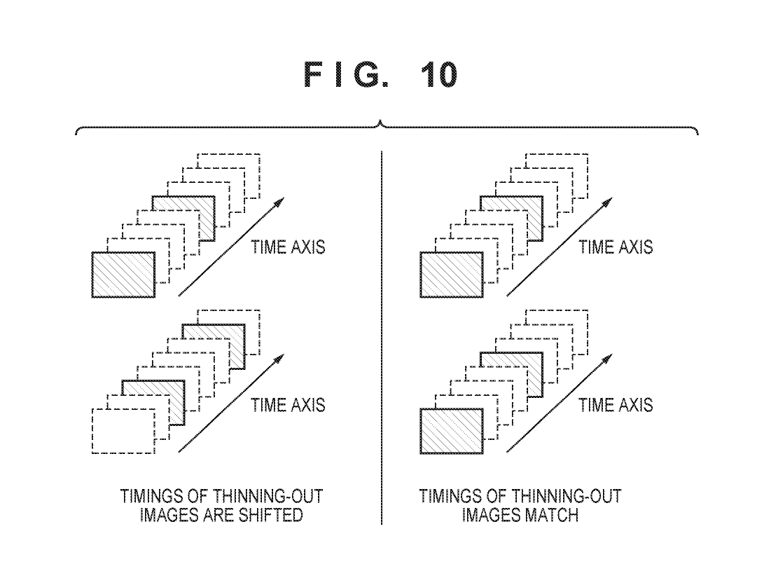

FIG. 9 shows an example in which the same video recording conditions are set in the cameras capturing the same region. As described above with reference to FIG. 4, cameras 1 to 5 capture the interior of the same room that is the same region. As shown in FIGS. 8A to 8C, the lower limits of the image resolution and frame rate of camera 1 are larger than the image analysis prerequisites of cameras 2 to 5 for real-time monitoring and respective recording conditions. Therefore, as shown in hatched portions of FIG. 9, the values of the image resolution and frame rate of each of cameras 2 to 5 are made to match the values of the image resolution and frame rate of camera 1. As described above, for each of the plurality of image data, it becomes easy to integrate captured images having the same target image capturing range to perform significant analysis by deciding a format in accordance with the image capturing range of an image capturing apparatus which has captured the image data.

FIG. 10 shows examples in which the frame times are shifted and the frame times are made to match after thinning-out images. There are eight images from each of different cameras, and one out of four images is left after thinning-out. Hatched rectangles represent the images to be left after thinning-out, and dotted rectangles represent the images to be thinned-out. In the example of the left side in FIG. 10 in which timings of thinning-out the frames are shifted, it can be found that the different images are left between the upper and lower views. In the monitoring cameras which capture the same region, the imaging times of the images to be left need to match as much as possible as shown in the right side of FIG. 10. As described above, analysis performed by integrating captured images of a predetermined image capturing range becomes easy by fixing, to the same format, the formats, such as a timing of a frame, of image data obtained by the image capturing apparatuses which capture the same imaging range.

In step S140, the setting recording unit 420 presents a long-term recording setting which exceeds the lower limit of the long-term recording setting. If video recording is performed as long as possible, the lower limit itself can be presented. If image quality is given priority, a large value is presented within a range not exceeding a disk capacity. Since this is a matter of balance, a desirable value is presented based on a system setting or user setting. As described above, the setting recording unit 420 may decide not the range of each parameter but the value of each parameter, and present it.

Finally, the user confirms a recommended value presented on the display unit 410, and if there is no problem, the setting recording unit 420 reflects the setting in step S150. The setting designated here is recorded in the setting recording unit 420 and also transmitted to the image recording apparatus 200 via the communication unit 401. The transmitted setting is reflected as an actual video recording setting by the setting unit 202. If there is no contradiction in view of setting, confirmation of setting contents may be skipped, and the long-term recording setting may be performed automatically. That is, the setting unit 202 may automatically set, as the parameter for image data to be video recorded, the value of each parameter (such as the size or frame rate of an image) decided by the setting recording unit 420. Further, the setting unit 202 may be restricted such that it cannot set the parameter for the image data to be video recorded to a value falling outside a range decided by the setting recording unit 420. For example, inputting the value out of the range may be prohibited, or a value falling outside a range input by the user may be invalidated.

FIG. 5 shows an example in which the user first makes the long-term recording setting. However, the long-term recording setting may be presented at an arbitrary timing. For example, if the above-described setting is made when the user changes the number of connected cameras or when the image analysis setting is added, it is possible to urge the user to make the long-term recording setting free from contradiction all the time. The long-term recording setting has already been made in the second or subsequent process. However, if there is any contradiction with a current setting in step S140 described above, this can be displayed on the UI.

As described above, the management apparatus 400 of this embodiment obtains the plurality of image data captured by the plurality of monitoring cameras 100 and performs storage control of causing the image recording apparatus 200 to store the plurality of obtained image data as analysis targets by the image analysis apparatus 300. For each image data, the management apparatus 400 decides the format of the image data in the image recording apparatus 200 in accordance with the contents of analysis performed on the image data and causes the image recording apparatus 200 to store the plurality of image data in the decided format. This makes it possible to easily set, for each image data, a suitable recording setting according to the analysis contents without the user manually making setting. It is also possible to easily make the image analysis setting and the long-term recording setting without any contradiction by deciding the format of the image data in accordance with a time elapsed since the image data is captured.

### Second Embodiment

In the second embodiment of the present invention, not only an image analysis setting and a camera installation position but also a disk status and the congestion status of a network are used.

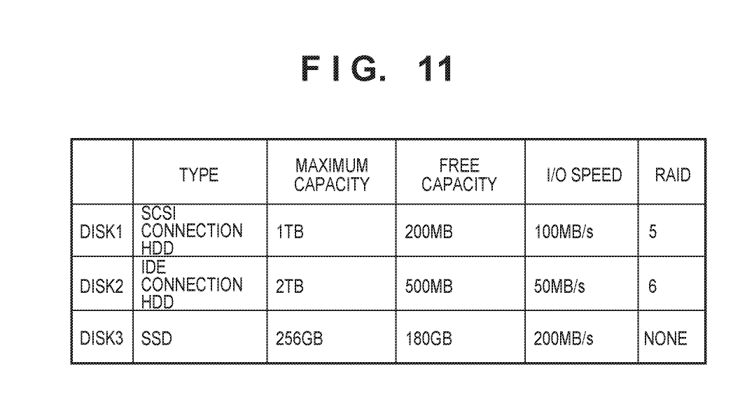

More specifically, when a system status is collected in step S120 of FIG. 5, a state confirmation unit 433 obtains the disk status in step S123. FIG. 11 shows an example of each disk status. In this example, three disks different in performance are connected to an image recording apparatus 200. Disk 3 can read and write at high speed but is small in capacity. Disk 2 has a large recording capacity, and its failure resistance is secured by RAID, but it has the lowest read/write speed. Disk 1 keeps balance between a speed and a size.

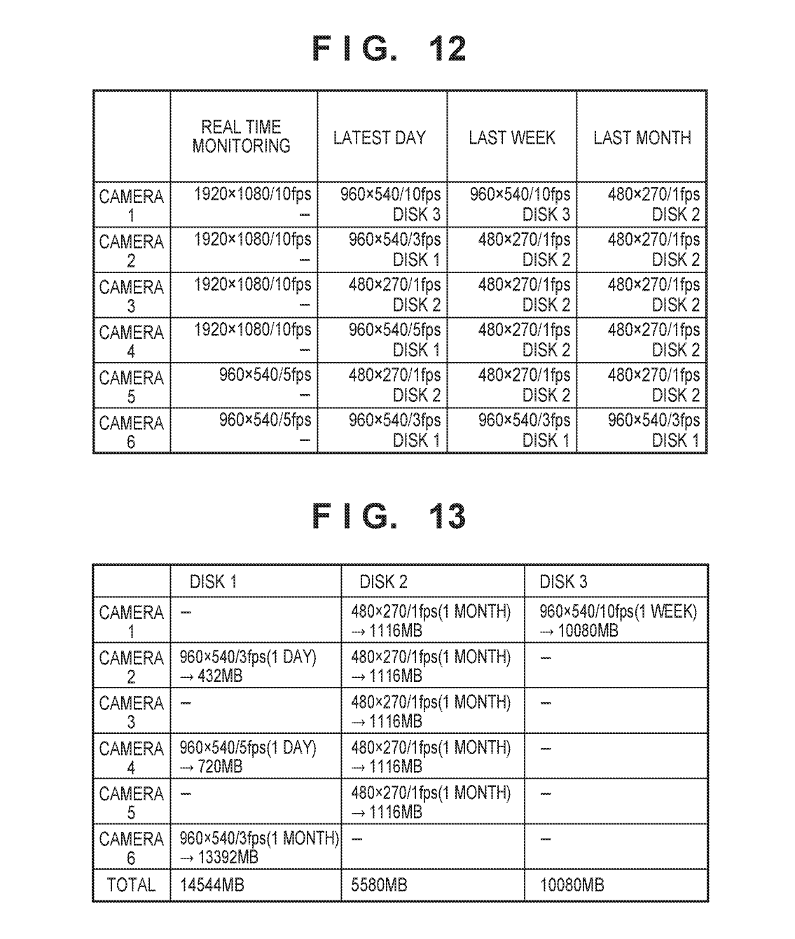

Under this environment, an image of a camera in which a large amount of read/write data is generated by image analysis is saved in disk 2, an image for long-term recording not planned to undergo image analysis is saved in disk 3, and data other than these is saved in disk 1. More specifically, an image to undergo “person position estimation” and “passing person count” is recorded in disk 3, an image to undergo “age estimation” and “gender estimation” is recorded in disk 1, and an image not to undergo image analysis is recorded in disk 2. In this case, the recording destination of long-term recording data is as shown in FIG. 12.

In reality, a writable disk I/O speed or a recording capacity may be exceeded. To prevent this, whether there is no problem needs to be confirmed for each disk after saving data.

FIG. 13 shows a table which provides a summary of the recording capacity for each disk in terms of the recording capacity. This time, calculation is performed based on the lower limit of a recording setting, and thus the I/O speed or a disk capacity is never exceeded. However, the disk capacity may be exceeded when the number of cameras increases, or an image resolution/frame rate is set high. In this case, the image recording destination of some cameras is changed to another higher-performance disk. A warning is urged if a calculated long-term recording setting is impossible with a current disk capacity. Note that in FIG. 13, the data size of an image per frame is as follows.

1,920×1,080 pixels: 10 KB

960×540 pixels: 40 KB

480×270 pixels: 10 KB

As described above, in this embodiment, the format of image data is decided in accordance with the status of the image recording apparatus 200. More specifically, for example, each image data is stored in a disk, out of a plurality of disks, decided in accordance with at least contents of analysis performed on the image data or a disk status. Note that the disk status includes at least one of a free space and read/write speed. This makes it possible to record a captured image in a more suitable storage medium in accordance with the disk status without requiring a troublesome manual operation.

A similar check is performed not only on the disks but also on a network band. That is, in step S124, a band confirmation unit 434 obtains the usage status of the network band, and if a predetermined condition is satisfied on which data transfer becomes difficult or impossible in that band, a disk connected to another network is selected, or a warning is urged. For example, a case in which network congestion occurs (the size of data flowing on a network is equal to or larger than a threshold, the proportion of discarded packets is equal to or higher than a threshold, or the like) or a case in which a writing speed of a recording data size is exceeded applies to such a condition.

As described above, it becomes possible to avoid an image defect or an analysis failure by storing each image data in a disk, out of the plurality of disks, decided in accordance with a communication speed between each disk and a plurality of image capturing apparatuses.

As described above, in each embodiment of the present invention, the long-term recording setting of the image data is made in the monitoring camera system in accordance with, for example:

the image capturing apparatus installation position capable of judging whether the same region is captured

the image analysis setting including an analysis execution timing or a target camera

the operation state of a recording unit including the free space and read/write speed

the usage status of a network band which connects the camera and the recording unit This makes it possible to easily set long-term recording of images free from contradiction with a video analysis setting even in a large-scale system in which a plurality of monitoring cameras are connected.

According to each embodiment described above, it is possible to provide a technique capable of setting image analysis and image recording appropriately.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2016-009138, filed Jan. 20, 2016, which is hereby incorporated by reference herein in its entirety.

What is claimed is:

1. An information processing apparatus comprising:
an information obtaining unit configured to obtain setting information indicating a setting of image analysis processing performed on image data recorded in a recording unit configured to record the image data captured by an image capturing unit; and
a decision unit configured to decide, in accordance with the setting information, one of a value of a parameter for the image data to be recorded in the recording unit, which influences a data amount of the image data, and a range of the value of the parameter.

2. The apparatus according to claim 1, further comprising a display control unit configured to cause a display unit to display information indicating one of the value of the parameter and the range of the value of the parameter decided by the decision unit.

3. The apparatus according to claim 1, further comprising a restriction unit configured to restrict the range of the value of the parameter for the image to be data recorded in the recording unit to the range decided by the decision unit.

4. The apparatus according to claim 1, further comprising a setting unit configured to set the value of the parameter for the image data to be recorded in the recording unit to the value decided by the decision unit.

5. The apparatus according to claim 1, wherein the parameter includes at least one of a size and a frame rate of an image.

6. The apparatus according to claim 1, wherein the parameter includes a timing of a frame of the image data to be recorded in the recording unit.

7. The apparatus according to claim 1, wherein the image data is converted into image data of a parameter different for each predetermined period and recorded in the recording unit,
the image analysis processing is performed, at a predetermined timing, on image data for a predetermined time recorded in the recording unit, and
the decision unit decides, based on a time corresponding to the image data to undergo the image analysis processing performed at the predetermined timing, one of the value of the parameter and the range of the value of the parameter for each predetermined period.

8. The apparatus according to claim 1, wherein the decision unit decides one of the value of the parameter and the range of the value of the parameter in accordance with a status of the recording unit.

9. The apparatus according to claim 8, wherein the status of the recording unit includes at least one of a read/write speed and a free space in the recording unit.

10. The apparatus according to claim 1, wherein the recording unit records a plurality of image data captured by a plurality of image capturing apparatuses,
the information obtaining unit obtains a plurality of pieces of setting information each indicating a setting of image analysis processing performed on each of the plurality of image data recorded in the recording unit, and
the decision unit decides, in accordance with the setting information in a first image capturing apparatus out of the plurality of image capturing apparatuses, one of the value of the parameter for the image data of a second image capturing apparatus different form the first image capturing apparatus and the range of the value of the parameter.

11. The apparatus according to claim 10, wherein the second image capturing apparatus is installed at a position capable of capturing at least part of a range that can be captured by the first image capturing apparatus.

12. The apparatus according to claim 1, wherein the recording unit records the image data transmitted from the image capturing unit.

13. The apparatus according to claim 1, wherein the parameter comprises a parameter which influences analysis precision in the image analysis processing.

14. The apparatus according to claim 1, wherein the image analysis processing includes at least one of age estimation processing, gender estimation processing, passing person count processing, and person position estimation processing.

15. An information processing method comprising:
obtaining setting information indicating a setting of image analysis processing performed on image data recorded in a recording unit configured to record the image data captured by an image capturing unit; and
deciding, in accordance with the setting information, one of a value of a parameter for the image data to be recorded in the recording unit, which influences a data amount of the image data, and a range of the value of the parameter.

16. A computer-readable non-transitory recording medium storing a program for causing a computer to function as:
an information obtaining unit configured to obtain setting information indicating a setting of image analysis processing performed on image data recorded in a recording unit configured to record the image data captured by an image capturing unit; and
a decision unit configured to decide, in accordance with the setting information, one of a value of a parameter which influences a data amount of the image data to be recorded the recording unit and a range of the value of the parameter.
